(19) United States
(12) Patent Application Publication
(10) Pub. No.: US 2011/0125570 A1
(43) Pub. Date: May 26, 2011

(54) METHOD AND APPARATUS FOR SELECTING CONTENT

(76) Inventor: Jennifer Schultz, Lawrenceville, GA (US)

(21) Appl. No.: 12/624,676

(22) Filed: Nov. 24, 2009

(51) Int. Cl. G06Q 30/00; G06Q 10/00; G06Q 50/00

(52) U.S. Cl. 705/14.42; 705/14.49

(57) ABSTRACT

Presently disclosed is a method and apparatus for selecting advertisement slot labels at a recommendation engine. Market research data is compared with multimedia content metadata. Advertisement slot labels are selected for advertisement slots of the multimedia content based on the comparison of the market research data and the multimedia content metadata.

A method and apparatus for selecting multimedia content for pairing with advertisement content using a recommendation engine is disclosed. Market research data is compared with advertisement content metadata. Multimedia content is selected to pair with advertisement content based on the comparison of the market research data and the advertisement content metadata.

A method and apparatus for selecting advertisement content is disclosed. Multimedia content metadata corresponding to multimedia content is sent. Advertisement slot label recommendation(s) for advertisement slots of the multimedia content are received. Advertisements for the advertisement slots are selected based on the advertisement slot label recommendation(s).

### BACKGROUND

The present disclosure relates to multimedia content. More particularly, and not by way of limitation, the present invention is directed to a method and apparatus for selecting advertisement content based on advertisement slot labels.

Existing methods for the selection of Advertisements either in traditional cable television or Video On Demand television focus on providing demographically significant advertisements, where demographs are identified by location, age, etc. An example of this would be commercials for toys being provided during hours in which children are often watching television.

Demographic targeting merely ensures that the appropriate advertisements reach the appropriate audience. They do not guarantee the effectiveness of the individual ads.

It would be advantageous to have apparatuses and methods for selecting advertisement content that overcomes the disadvantages of the prior art. The present invention provides such apparatuses and methods.

### SUMMARY

Presently disclosed, in one embodiment, is a method and apparatus for selecting advertisement slot labels at a recommendation engine of a server. Market research data is received. Multimedia content metadata that corresponds to multimedia content is received. The received market research data is compared with the received multimedia content metadata. One or more advertisement slot labels are selected for one or more advertisement slots of the multimedia content based on the comparison of the received market research data and the received multimedia content metadata.

In another embodiment, a method and apparatus for selecting multimedia content for pairing with advertisement content using a recommendation engine of a server is disclosed. Multimedia content metadata is received. Advertisement content metadata is received. Market research data is received. The received market research data is compared with the received advertisement content metadata. Multimedia content is selected to pair with the advertisement content based on the comparison of the received market research data do the received advertisement content metadata.

In yet another embodiment, a method and apparatus for selecting advertisement content is disclosed. Multimedia content metadata that corresponds to multimedia content is sent. One or more advertisement slot label recommendations for one or more advertisement slots of the multimedia content are received. Advertisements for the advertisement slots are selected based on the received advertisement slot label recommendations.

### BRIEF DESCRIPTION OF THE DRAWINGS

In the following section, the invention will be described with reference to exemplary embodiments illustrated in the figures, in which:

FIG. 1 illustrates an advertisement recommendation and selection system in accordance with one embodiment;

FIG. 2 illustrates an advertisement recommendation module in accordance with one embodiment;

FIG. 3 illustrates a method for recommending advertisement content in accordance with one embodiment;

FIG. 4 illustrates a method for recommending multimedia content for pairing with advertisement content in accordance with one embodiment;

FIG. 5 illustrates a method for selecting advertisement content according to one embodiment; and

FIG. 6 illustrates a block diagram of an advertisement recommendation and selection device or system in accordance with one embodiment.

### DETAILED DESCRIPTION

Advertisement slots are labeled appropriately with respect to the multimedia, e.g., television, content immediately before and after the advertisement slot. Using advertisement slot labeling in this manner maximizes the effectiveness of the advertisement.

Using existing or newly gathered statistical data on consumer response to various types of advertisements after various types of content, labels will be associated with certain types of television content. For example, research may show that “funny” advertisements are most effective after cooking shows, while “serious” advertisements work best before and after dramas. Labels may be of any sort, that is, commercials could be labeled based on content (food, toys, life insurance, etc.) or method (humor, celebrities, etc.) length or any other means. A particular slot may have several types of labels, listed in order of researched effectiveness. Once advertising slots have been automatically labeled, appropriate (human labeled) ads would fill them to maximize their effectiveness. Such advertisements may have several labels associated with them (for instance, an ad can be labeled as “funny” as well as “food”).

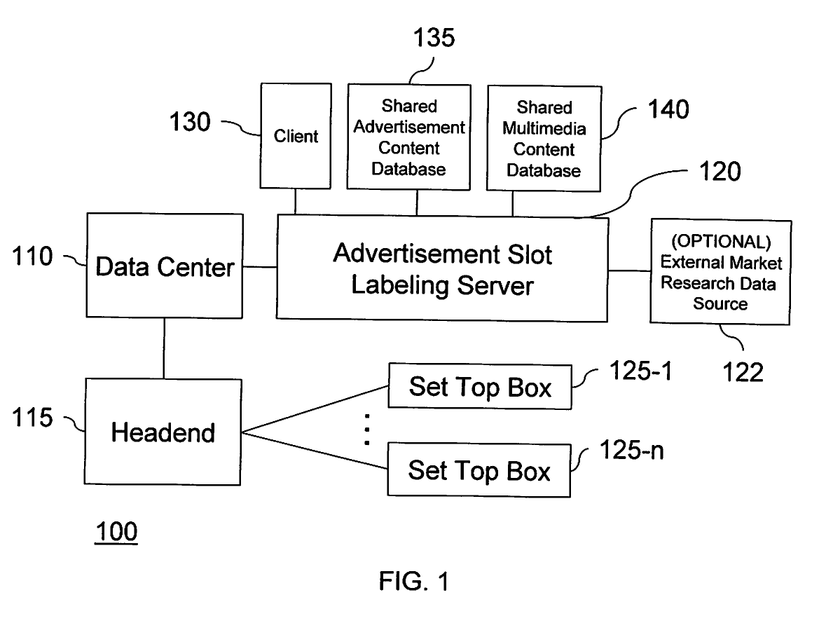

FIG. 1 illustrates an advertisement recommendation and selection system 100 in accordance with one embodiment. Data center 110 inserts advertisements in advertisement slots of multimedia content provided by headend 115 to a plurality of set top boxes 125-1 . . . 125-n. In one embodiment, headend 115 is a Video on Demand (VOD) headend. Data center 110 sends multimedia content metadata to advertisement slot labeling server 120. The multimedia content metadata may be sent using Extensible Markup Language (XML) over Hypertext Transfer Protocol (HTTP). Advertisement slot labeling server 120 receives market research data, e.g., statistical data. This market research data may be stored locally in advance. In one embodiment market research data is acquired from external market research data source 122 by advertisement slot labeling server 120 in response to receiving the multimedia content metadata. Based on a comparison of the market research data and the multimedia content metadata, advertisement slot labeling server 120 selects one or more advertisement slot labels for one or more advertisement slots of the multimedia content to data center 110.

In one embodiment, advertisement slot labeling server 120 selects multimedia content for pairing with advertisement content. Advertisement slot labeling server 120 receives multimedia content metadata from shared multimedia content database 140, e.g, a content database located in a video on demand (VOD) server at headend 115. In one embodiment, the multimedia content metadata corresponds to a plurality of multimedia content, each of the plurality of multimedia content having one or more corresponding multimedia content labels. Advertisement content metadata e.g., corresponding to advertisement content having one or more advertisement content labels, is received at recommendation engine 215 of advertisement slot labeling server 120 from shared advertisement content database 135 or a user of client 130. Recommendation engine 215 of advertisement slot labeling server 120 requests market research data, e.g. an effectiveness percentage for the one or more advertisement content labels. Market research data is received at recommendation engine 215 of advertisement slot labeling server 120. The market research data, e.g., statistical data, corresponds to consumer response to certain types of advertisement content that is shown after certain types of multimedia content, e.g. broadcast television content or video on demand (VOD) content. Market research data may be stored in advance in market research database 220 or acquired from external market research data source 122. Recommendation engine 215 compares the received market research data with the received advertisement content metadata. Based on the effectiveness percentage attributed to the received advertisement content metadata, recommendation engine 215 outputs an effectiveness percentage of the advertisement content for each of the multimedia contents according to the multimedia content's corresponding multimedia content label(s). In one embodiment, multimedia contents are recommended by recommendation engine 215 to be paired with the advertisement content when the effectiveness percentage for the advertisement/multimedia content pair meets a predefined threshold. In one embodiment, the recommendation engine recommends the multimedia content that provides the highest effectiveness percentage for the advertisement content_Multimedia content is then selected for pairing with the advertisement content based on the comparison of the received market research data, e.g., the effectiveness percentage, and the received advertisement content metadata.

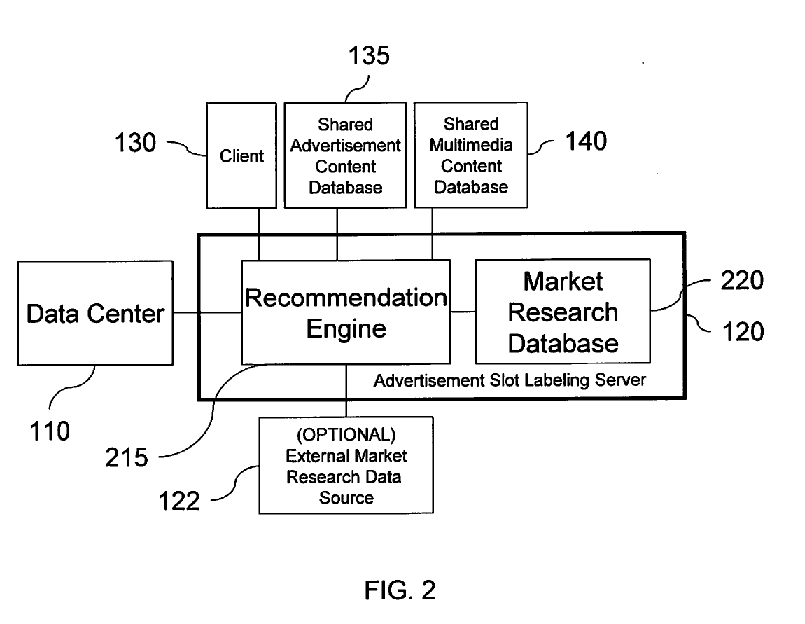

FIG. 2 illustrates an advertisement slot labeling server 120 in accordance with one embodiment. Market research data, e.g., statistical data, is stored in market research database 220. The market research data may be stored locally in advance or acquired from external market research data source 122 in response to receiving multimedia content metadata that corresponds to multimedia content having one or more advertisement slots. Recommendation engine 215 receives multimedia content metadata and compares this multimedia content data with the market research data from market research database 220 or from external market research data source 122. Based on the comparison, recommendation engine 215 selects one or more advertisement slot labels for the one or more advertisement slots.

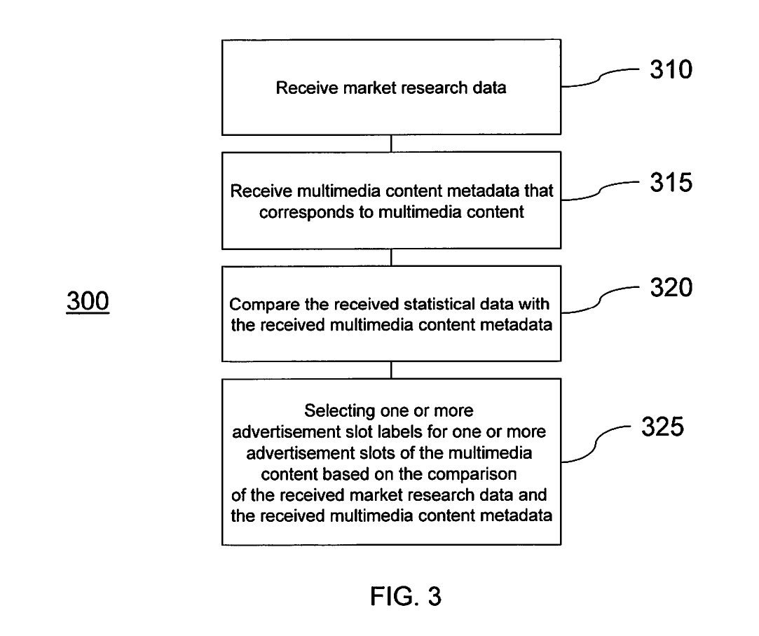

FIG. 3 illustrates a method 300 for recommending advertisement content according to one embodiment. At step 310, market research data is received at recommendation engine 215 of advertisement slot labeling server 120. The market research data, e.g., statistical data, corresponds to consumer response to certain types of advertisement content that is shown after certain types of multimedia content, e.g. broadcast television content or video on demand (VOD) content. Market research data may be stored in advance in market research database 220 or acquired from external market research data source 122.

At step 315, multimedia content metadata that corresponds to multimedia content is received at recommendation engine 215 from data center 110. At step 320 the recommendation engine compares the received market research data with the received multimedia content metadata. In one embodiment, the received market research data is advertisement effectiveness data.

For example, the market research data can be simple facts, such as: “Funny advertisements are 90% effective when paired with Comedy movie content” or “Food advertisements are 1% effective when paired with Horror movie content”. When multimedia content metadata is given to the recommendation engine, the recommendation engine uses these simple advertisement/content pairings to generate complex recommendations, e.g. a consolidated recommendation.

For example, an advertisement may be categorized or labeled as “Funny, Food, Children, Health”. In this case, recommendation engine 215 would access all “Funny”, “Food”, “Children” and “Health” advertisement/content pairings, and determine a set of consolidated recommendations based on the advertisement/content pairings.

In another example, database 220 has the following pairings: “Health advertisements are 10% effective on Cartoons”, “Food advertisements are 70% effective on Cartoons”, “Children advertisements are 90% effective on cartoons”. “Funny advertisements are 80% effective on cartoons”. Thus, to generate the recommendation for how effective the “Funny, Food, Children, Health” advertisement would be for multimedia content metadata having a label of “Cartoons”, those four pairings have to be consolidated into one consolidated recommendation. In one embodiment, a consolidated recommendation, e.g. an effectiveness percentage, is made by taking the averages of the four pairings. In this case, the recommendation engine would have an output like “Funny, Food, Children, Health advertisements are 63% effective when paired with Cartoons’. The recommendation would repeat this for every type of video content (for example, “Horror”, “Comedy”, “Family”, “Drama”).

The database contains simple pairings, while ads themselves are very complex. The recommendation engine turns many simple pairings into a single complex one to determine the best place to put an ad.

Additionally, the recommendation engine could work in the opposite direction. With linear television having already known video content, the recommendation engine can find the best type of ad to place based on known content attributes. In this case inputting a content type “Horror” (or a more complex combination of content types) would receive as output the qualities of an effective advertisement for that content type or content types.

At step 325, one or more advertisement slot labels are selected for one or more advertisement slots of the multimedia content based on the comparison of the received market research data and the received multimedia content data. The selection of recommendation engine 215 is then provided to data center 110.

In a further example corresponding to FIG. 3, the recommendation engine compares the received multimedia content metadata, e.g. corresponding to multimedia content that has content labels of horror and comedy, with the advertisement effectiveness data (received from the database) corresponding to the content label(s). The recommendation engine calculates consolidated recommendations based on the advertisement effectiveness data that corresponds to the content label(s). Thus, the recommendation engine provides an effectiveness percentage for every type of advertisement content label or combination of advertisement content labels that is known by the recommendation engine to correspond to the received multimedia content label(s). In one embodiment, an advertisement content label or combination of advertisement labels having effectiveness percentages meeting a predefined threshold are eligible for recommendation by the recommendation engine. In one embodiment, the recommendation engine recommends the advertisement label or combination of advertisement labels having the highest effectiveness percentage for an advertisement slot.

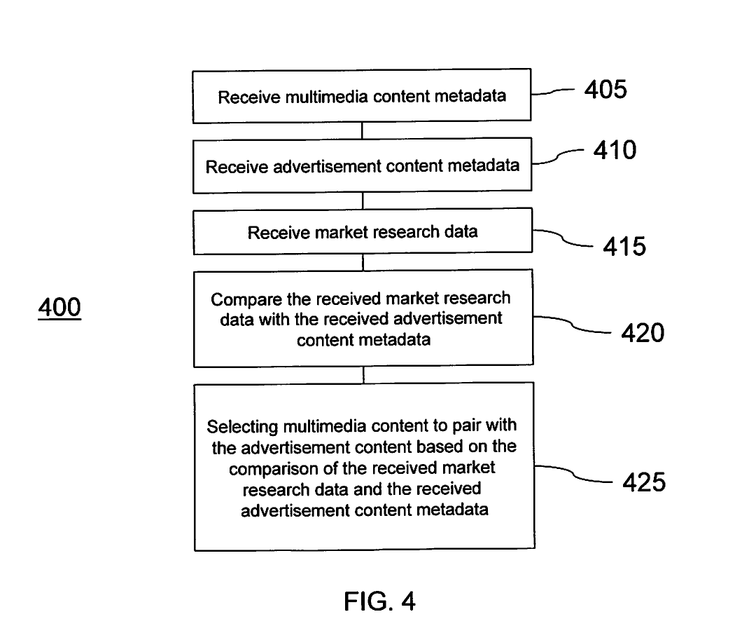

FIG. 4 illustrates a method 400 for selecting multimedia content for pairing with advertisement content according to one embodiment. At step 405, recommendation engine 215 receives multimedia content metadata from a shared multimedia content database 140, e.g, a content database located in a video on demand (VOD) server at headend 115. In one embodiment, the multimedia content metadata corresponds to a plurality of multimedia contents, each of the plurality of multimedia contents having one or more corresponding multimedia content labels.

At step 410, advertisement content metadata e.g., corresponding to advertisement content having one or more advertisement content labels, is received at recommendation engine 215 from shared advertisement content database 135 or a user of client 130.

At step 415, recommendation engine 215 requests market research data, e.g. an effectiveness percentage (as described with respect to FIG. 3) for the one or more advertisement content labels. At step 420 market research data is received at recommendation engine 215 of advertisement slot labeling server 120. The market research data, e.g., statistical data, corresponds to consumer response to certain types of advertisement content that is shown after certain types of multimedia content, e.g. broadcast television content or video on demand (VOD) content. Market research data may be stored in advance in market research database 220 or acquired from external market research data source 122.

At step 425 the recommendation engine compares the received market research data with the received advertisement content metadata. Based on the effectiveness percentage attributed to the received advertisement content metadata, recommendation engine 215 provides an effectiveness percentage of the advertisement content for each of the multimedia contents according to the multimedia content's corresponding multimedia content label(s). In one embodiment, multimedia contents are recommended by recommendation engine 215 to be paired with the advertisement content when the effectiveness percentage for the advertisement/multimedia content pair meets a predefined threshold. In one embodiment, the recommendation engine recommends the multimedia content that provides the highest effectiveness percentage for the advertisement content.

At step 430, multimedia content is selected for pairing with the advertisement content based on the comparison of the received market research data, e.g., the effectiveness percentage, and the received advertisement content metadata.

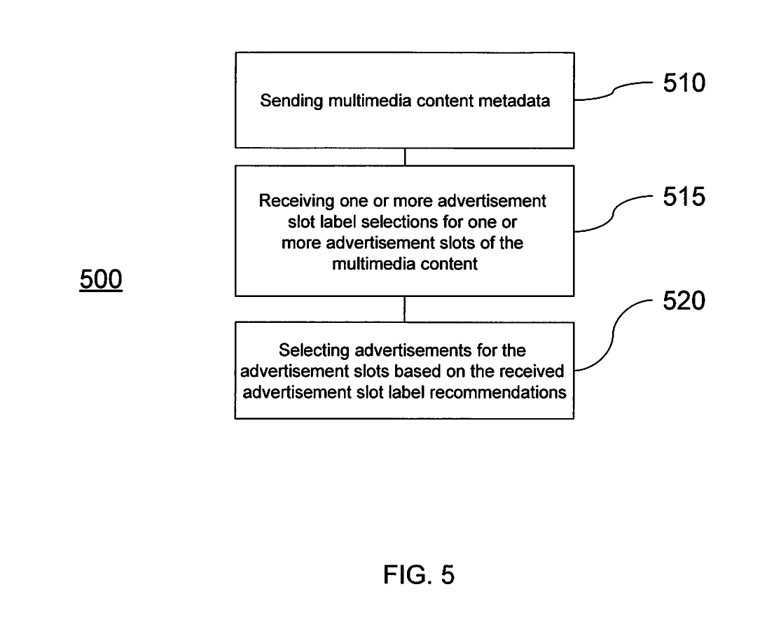

FIG. 5 illustrates a method 500 for selecting advertisement content according to one embodiment. At step 510, multimedia content metadata corresponding to multimedia content is sent to advertisement slot labeling server 120. At step 515, one or more advertisement slot label recommendations for one or more advertisement slots of the multimedia content are received from advertisement slot labeling server 120. The advertisement slot label recommendations are based on a comparison from recommendation engine 215 of market research data and the multimedia content data. At step 520, advertisements for the one or more advertisement slots are selected based on the received advertisement slot label recommendations.

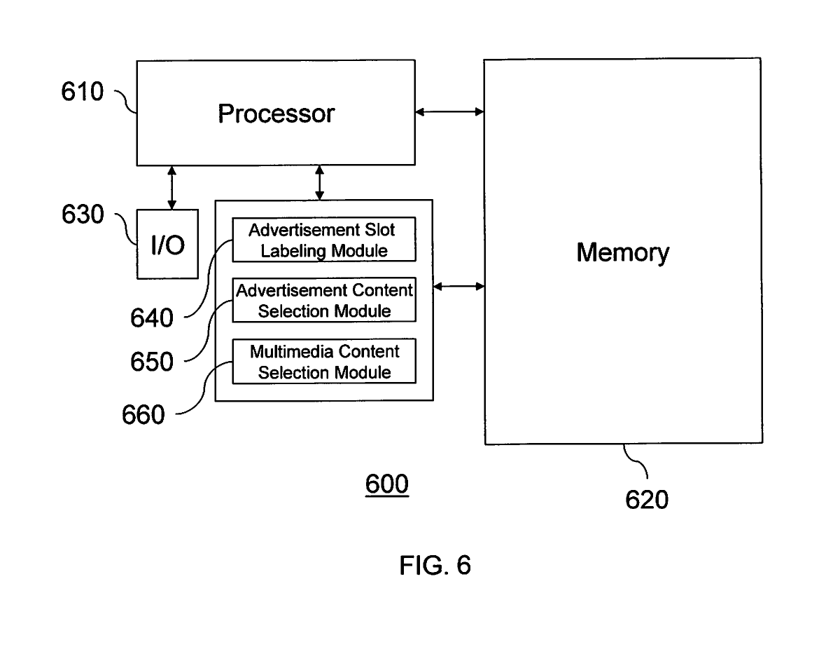

FIG. 6 illustrates a block diagram of an advertisement recommendation and selection device or system 600 of the present disclosure. Specifically, the system can be employed to provide advertisement slot label selections based on market research data and multimedia content metadata and select advertisements for advertisement slots based on the advertisement slot label recommendations. In one embodiment, advertisement recommendation and selection device or system 600 is implemented using a general purpose computer or any other hardware equivalents.

Thus, advertisement recommendation and selection device or system 600 comprises a processor (CPU) 610, a memory 620, e.g., random access memory (RAM) and/or read only memory (ROM), Advertisement Slot Labeling Module 640, Advertisement Content Selection Module 650, Multimedia Content Selection Module 660, and various input/output devices 630, (e.g., storage devices, including but not limited to, a tape drive, a floppy drive, a hard disk drive or a compact disk drive, a receiver, a transmitter, a speaker, a display, a clock, an output port, a user input device (such as a keyboard, a keypad, a mouse, and the like)).

It should be understood that Advertisement Slot Labeling Module 640, Advertisement Content Selection Module 650, and Multimedia Content Selection Module 660 may be implemented as one or more physical devices that are coupled to CPU 610 through a communication channel. Alternatively, Advertisement Slot Labeling Module 640, Advertisement Content Selection Module 650, and Multimedia Content Selection Module 660 may be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 620 of the computer. As such, Advertisement Slot Labeling Module 640, Advertisement Content Selection Module 650, and Multimedia Content Selection Module 660 (including associated data structures) of the present disclosure can be stored on a computer readable medium, e.g., RAM memory, magnetic or optical drive or diskette and the like. In one embodiment, Advertisement Slot Labeling Module 640 may be implemented using method 300 at data center 110 or server 120. In another embodiment Advertisement Content Selection Module may be implemented using method 500 at data center 110. In yet another embodiment, Multimedia Content Selection Module may be implemented using method 400 at data center 110 or server 120.

One advantage of advertisement slot labeling is that labeling advertisements in the manner provided by the disclosure immediately provides some measure of guarantee of advertisement effectiveness, while being able to fold in data regarding demographics. For instance, ‘toy’ labeled advertisements might be most effective after cartoons, this label would effectively capture all of the information demographically targeted advertisements provided, while also allowing for more detailed advertisement targeting. For example, ‘toy’ ‘funny’ ‘fun’ advertisements might be most effective earlier in the day, while ‘toy’ ‘serious’, ‘value’ might work better later in the day when parents might be watching the advertisements with their children. Better targeted advertisements provide more return for advertisers.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method for selecting advertisement slot labels at a recommendation engine of a server, comprising:
receiving market research data;
receiving multimedia content metadata that corresponds to multimedia content;
comparing the received market research data with the received multimedia content metadata;
selecting one or more advertisement slot labels for one or more advertisement slots of the multimedia content based on the comparison of the received market research data and the received multimedia content metadata.

2. The method of claim 1, wherein the market research data comprises advertisement effectiveness data.

3. The method of claim 1, wherein the received content metadata comprises one or more multimedia content labels.

4. The method of claim 3, wherein the recommendation engine provides an effectiveness percentage for each advertisement content label or combination of advertisement content labels that corresponds to the one or more multimedia content labels.

5. The method of claim 4, wherein the advertisement label or combination of advertisement labels having effectiveness percentages meeting a predefined threshold are eligible for recommendation by the recommendation engine.

6. The method of claim 4, wherein the recommendation engine recommends the advertisement label or combination of advertisement labels having a highest effectiveness percentage for an advertisement slot.

7. An apparatus comprising an advertisement slot label server for recommending advertisement content, comprising:
a market research database; and
a recommendation engine, where the recommendation engine,
receives market research data from the market research database or from an external source;
receives multimedia content metadata that corresponds to multimedia content from a data center;
compares the received market research data with the received multimedia content metadata; and
selects one or more advertisement slot labels for one or more advertisement slots of the multimedia content based on the comparison of the received market research data and the received multimedia content metadata.

8. A method for selecting multimedia content for pairing with advertisement content using a recommendation engine of a server, comprising:
receiving multimedia content metadata;
receiving advertisement content metadata;
receiving market research data;
comparing the received market research data with the received advertisement content metadata; and
selecting multimedia content to pair with the advertisement content based on the comparison of the received market research data and the received advertisement content metadata.

9. The method of claim 8, wherein the advertisement content metadata corresponds to advertisement content.

10. The method of claim 9, wherein the multimedia content metadata corresponds to a plurality of multimedia contents.

11. The method of claim 10, wherein the recommendation engine provides an effectiveness percentage of the advertisement content for each of the plurality of multimedia contents.

12. The method of claim 11, wherein the recommendation engine recommends one or more multimedia contents to be paired with the advertisement content when the effectiveness percentage meets a predefined threshold.

13. The method of claim 11, wherein the recommendation engine recommends the multimedia content that provides a highest effectiveness percentage for the advertisement content.

14. The method of claim 9, wherein the market research data comprises effectiveness percentages for the advertisement content.

15. A method for selecting advertisement content, comprising:
sending multimedia content metadata that corresponds to multimedia content;
receiving one or more advertisement slot label recommendations for one or more advertisement slots of the multimedia content;
selecting advertisements for the advertisement slots based on the received advertisement slot label recommendations.
